(19) United States
(12) Patent Application Publication
(10) Pub. No.: US 2020/0182970 A1
(43) Pub. Date: Jun. 11, 2020

(54) METHOD AND DEVICE FOR DETECTING SPOT POSITION

(71) Applicant: INDUSTRIAL TECHNOLOGY RESEARCH INSTITUTE, Hsinchu (TW)

(72) Inventors: Hung-Jui Ting, Taoyuan City (TW); Chih-Han Yen, Tainan City (TW); Pin-Chen Wang, Taichung City (TW)

(73) Assignee: INDUSTRIAL TECHNOLOGY RESEARCH INSTITUTE, Hsinchu (TW)

(21) Appl. No.: 16/460,671

(22) Filed: Jul. 2, 2019

(30) Foreign Application Priority Data
Dec. 6, 2018 (TW) 107143906

(51) Int. Cl. G01S 7/48; G01S 17/42

(52) U.S. Cl. CPC G01S 7/4808; G01S 17/93; G01S 17/42

(57) ABSTRACT

A method for detecting spot position is provided. The method includes the following steps. Firstly, a number of primary light sensing pixels are enabled, wherein each primary light sensing pixel includes a number of secondary light sensing pixels. Then, a region of the primary light sensing pixels in which a light the spot is located is determined according to a first sensing value received by each primary light sensing pixel. Then, the secondary light sensing pixels outside the region are disabled. Then, a position of the spot is obtained according to a second sensing value received by the secondary light sensing pixels that are not disabled.

This application claims the benefit of Taiwan application Serial No. 107143906, filed Dec. 6, 2018, the disclosure of which is incorporated by reference herein in its entirety.

### TECHNICAL FIELD

The disclosure relates in general to a method and a device for detecting spot position.

### BACKGROUND

Generally speaking, the distance measuring device emits a measuring light to a test object. The measuring light is reflected to a light sensor of the distance measuring device from the test object. The distance measuring device calculates a distance between the test object and the distance measuring device according to a spot position of the light sensor. The more precisely the spot position is calculated, the more precise the distance measured by the distance measuring device will be. Therefore, it has become a prominent task for the industries to increase the precision at detecting the spot position.

### SUMMARY

According to one embodiment, a method for detecting spot position. The method includes the following steps. A number of primary light sensing pixels are enabled, wherein each primary light sensing pixel includes a number of secondary light sensing pixels. A region of the primary light sensing pixels in which a light the spot is located is determined according to a first sensing value received by each primary light sensing pixel. The secondary light sensing pixels outside the region are disabled. A position of the spot is obtained according to a second sensing value received by the secondary light sensing pixels that are not disabled.

According to another embodiment, a method used in a distance measuring method of a distance measuring device is provided. The distance measuring device includes a light source and a light sensor. The light sensor includes a number of primary light sensing pixels, wherein each primary light sensing pixel includes a number of secondary light sensing pixels. The method includes the following steps. A first measuring light is emitted to a test object by the light source. The primary light sensing pixels are enabled. A region of the primary light sensing pixels in which the spot of the first reflective light is located is determined according to a first sensing value of a first reflective light received by each primary light sensing pixel. The secondary light sensing pixels outside the region are disabled. A second measuring light is emitted to the test object by the light source. A position of the spot of the second reflective light is obtained according to a second sensing value of a second reflective light received by the secondary light sensing pixels that are not disabled. A distance between the device and the test object is obtained according to the position of the spot.

According to an alternative embodiment, a distance measuring device is provided. The device includes a light sensor, a light source and a processor. The light sensor includes a number of primary light sensing pixels, wherein each primary light sensing pixel includes a number of secondary light sensing pixels. The light source is configured to emit a first measuring light to a test object. The processor is configured to: enable the primary light sensing pixels; determine a region of the primary light sensing pixels in which the spot of the first reflective light is located according to a first sensing value of a first reflective light received by each primary light sensing pixel; and disable the secondary light sensing pixels outside the region. The light source is further configured to emit a second measuring light to the test object. The processor is further configured to: obtain a position of the spot of the second reflective light according to a second sensing value of a second reflective light received by the secondary light sensing pixels that are not disabled; and obtain a distance between the device and the test object according to position of the spot.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a functional block diagram of a device for detecting pot position according to an embodiment of the present disclosure.

FIG. 2 is a flowchart of detecting spot position by the device of FIG. 1.

FIG. 3 is a schematic diagram of primary light sensing pixels of the light sensor of FIG. 1.

FIG. 4 is a schematic diagram of measurement error curves of the spot position measured by the device of FIG. 1.

FIG. 5 is a schematic diagram of primary light sensing pixels of the light sensor of the device according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

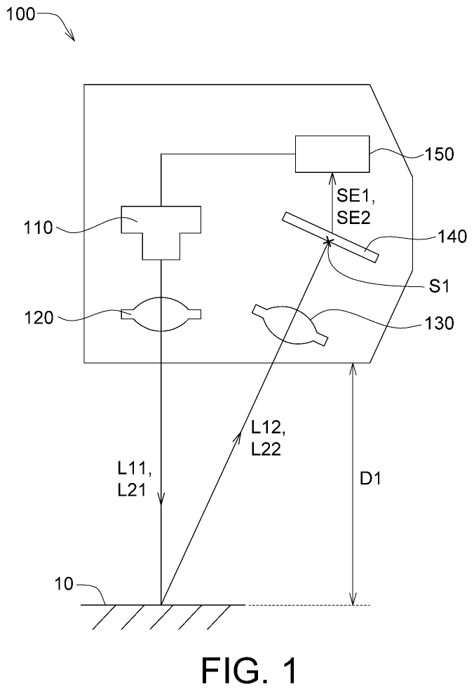

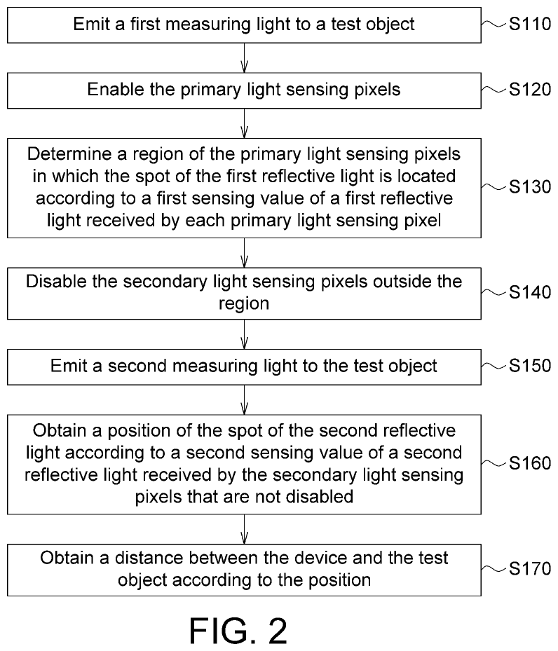

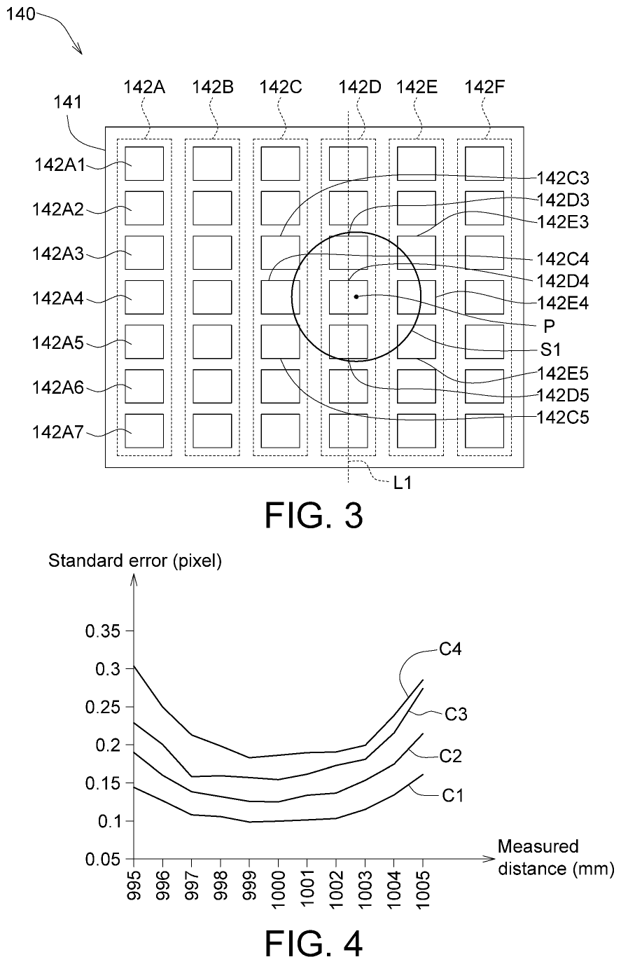

Refer to FIGS. 1 to 3. FIG. 1 is a functional block diagram of a device 100 for detecting pot position according to an embodiment of the present disclosure. FIG. 2 is a flowchart of a process for detecting a position P of a spot S1 by the device 100 of FIG. 1. FIG. 3 is a schematic diagram of primary light sensing pixels 142A to 142F of the light sensor 140 of FIG. 1.

The device 100, such as a distance measuring device, can detect a distance D1 between a device 100 and a test object 10. The device 100 includes a light source 110, a first lens 120, a second lens 130, a light sensor 140 and a processor 150. The light source 110 is coupled with the first lens 120, and the second lens 130 is coupled with the light sensor 140. In the present embodiment, the optical path of the light emitted by the light source 110 sequentially passes through the first lens 120, the test object 10, the second lens 130 and the light sensor 140.

The light source 110 is configured to emit a first measuring light L11 to the test object 10. Firstly, the first measuring light L11 enters the test object 10 via the first lens 120. Then, the first measuring light L11 is reflected from the test object 10 and becomes a first reflective light L12. The first reflective light L12 enters the light sensor 140 via the second lens 130 and forms a spot S1. The light sensor 140 includes a substrate 141 and a number of primary light sensing pixels, such as primary light sensing pixels 142A to 142F. The primary light sensing pixels 142A to 142F are formed on the substrate 141 to sense an intensity of the spot S1. Each of the primary light sensing pixels 142A to 142F generates a signal, such as a current or a voltage, according to the received intensity. The processor 150 is electrically connected to the light sensor 140 to receive a signal from the light sensor 140 and further calculates a position of the spot S1 according to the received signal. Besides, the processor 150 can enable or disable the primary light sensing pixels, and also can enable or disable the light sensing pixels of each primary light sensing pixel.

The process for detecting a position P of a spot S1 by the device 100 of FIG. 1 is disclosed in FIG. 2

In step S110, referring to FIG. 1 at the same time, the light source 110 is controlled by the processor 150 to emit a first measuring light L11 to the test object 10, wherein the first measuring light L11 is reflected from the test object 10 and becomes a first reflective light L12.

In step S120, at least one of the primary light sensing pixels of the light sensor 140 is enabled by the processor 150. In the present embodiment, all of the primary light sensing pixels 142A to 142F are enabled by the light sensor 140. In another embodiment, the quantity of the primary light sensing pixels and/or which ones of the primary light sensing pixel are to be enabled can be determined according to the position of the spot S1.

Each of the primary light sensing pixels 142A to 142F includes a number of secondary light sensing pixels. Let the primary light sensing pixel 142A be taken for example. The primary light sensing pixel 142A includes a number of secondary light sensing pixels 142A1 to 142A7. Furthermore, the quantity of the secondary light sensing pixels of each of the primary light sensing pixels 142A to 142F can be the same or different. However, neither the quantity of the primary light sensing pixels of the light sensor 140 nor the quantity of the secondary light sensing pixels of each light sensing pixel is subjected to any restrictions in the present disclosure. Moreover, the area of each secondary light sensing pixel of each of the primary light sensing pixels 142A to 142F is substantially the same or similar, but also can be different. In an embodiment, each secondary light sensing pixel of each primary light sensing pixel can be a polygon, a circle or an oval, wherein the polygon is such as a square, a rectangle a diamond or other shape of polygon. In an embodiment, the shape of each secondary light sensing pixel of each primary light sensing pixel can be formed of straight lines, curves or a combination thereof, and is not limited to above exemplifications.

In step S130, referring to FIG. 3 at the same time, a region of the primary light sensing pixels 142A to 142F in which the spot S1 of the first reflective light L12 is located is determined by the processor 150 according to a first sensing value SE1 of the first reflective light L12 received by each of the primary light sensing pixels 142A to 142F. Here, the first sensing value SE1 refers to an intensity or a current or a voltage of a corresponding electric signal. It can be understood from the present step that the processor 150 can enable all of primary light sensing pixels at one time to sense the region in which the spot S1 is located. Since the primary light sensing pixels are enabled at one time instead of several times, the detection speed of the spot S1 can be increased. Although it is exemplified in the present embodiment that the spot S1 covers three primary light sensing pixels, in another embodiment, the region of the spot S1 can cover only two or even more primary light sensing pixels.

In step S140, the secondary light sensing pixels outside the region of the spot S1 are disabled by the processor 150. For example, the processor 150 determines, according to the intensity detected by each of the primary light sensing pixels 142A to 142F, that the region of the spot S1 covers the secondary light sensing pixels 142C3 to 142C5 of the primary light sensing pixel 142C, the secondary light sensing pixels 142D3 to 142D5 of the primary light sensing pixel 142D and the secondary light sensing pixel 142E3 to 142E5 of the primary light sensing pixel 142E, and accordingly disables the secondary light sensing pixels outside the secondary light sensing pixels 142C3 to 142C5, 142D3 to 142D5 and 142E3 to 142E5.

In step S150, the light source 110 is controlled by the processor 150 to emit a second measuring light L21 to the test object 10. The second measuring light L21 is reflected from the test object 10 and becomes a second reflective light L22. Here, the second measuring light L21 refers to the light received given that some of the primary light sensing pixels 142A to 142F are enabled, while the first measuring light L11 disclosed above refers to the light received given that all of the primary light sensing pixels 142A to 142F are enabled. In an embodiment, the light source 110 continuously emits a measuring light at a light emitting frequency (such as is between 100 Hz to 100 KHz).

In step S160, the position of the spot S1 of the second reflective light L22 is obtained by the processor 150 according to the secondary light sensing pixels that are not disabled and a second sensing value SE2 of the second reflective light L22 received by the secondary light sensing pixels 142C3 to 142C5, 142D3 to 142D5 and 142E3 to 142E5. Here, the second sensing value SE2 refers to an intensity or a current or a voltage of a corresponding electric signal. Since all the secondary light sensing pixels outside the region of the spot S1 are disabled (no intensity can be sensed), the secondary light sensing pixels outside the region of the spot S1 will not receive any light but the reflective light (or will not receive any light, such as the ambient light, irrelevant to the reflective light). Thus, the light other than the reflective light, that is, the light which negatively affects the precision of detecting the position of the spot S1, will be less likely or even will not be detected, and the position of the spot S1 P calculated by the processor 150 will have higher precision.

In an embodiment, the processor 150 can calculate a position P of the spot S1 P using formula (1). The position P, such as a point at the region of the spot S1 (such as the center of centroid of the spot S1), is located at the center of mass or the centroid of at least one secondary light sensing pixel that is not disabled or the center of mass or the centroid of the region of distribution of the primary light sensing pixels of the at least one secondary light sensing pixel. In formula (1), the second sensing value SE2ᵢ represents a sensing value detected by the i^{th} primary light sensing pixel, and parameter N represents the quantity of all primary light sensing pixels. In the present embodiment, i is a positive integer, the primary light sensing pixels 142A to 142F of FIG. 3 respectively correspond to the positive integers 1 to 6 from left to right, and N is 6, but the present disclosure is not limited thereto.

$$P = \frac{{\sum }_{i = 1}^{N} ( SE {2}_{i} \times i )}{{\sum }_{i = 1}^{N} SE {2}_{i}} \qquad ( 1 )$$

Furthermore, since the primary light sensing pixel 142A (whose corresponding i is such as 1), the primary light sensing pixel 142B (whose corresponding i is such as 2) and the primary light sensing pixel 142F (whose corresponding i is such as 6) are disabled (no intensity can be sensed), the second sensing values SE2 received by the primary light sensing pixels 142A, 142B and 142 F are 0. Since the primary light sensing pixel 142C (whose corresponding i is such as 3), the primary light sensing pixel 142D (whose corresponding i is such as 4) and the primary light sensing pixel 142E (whose corresponding i is such as 5) are not disabled (intensity can be sensed), the intensity of the spot S1 can be received by the primary light sensing pixels 142C, 142D and 142E. The second sensing values SE2 received by the primary light sensing pixel 142C, 142D and 142E respectively are 2, 6 and 4. Based on formula (1), the position P of the spot S1 can be calculated as:

$$P = \frac{( 0 \times 1 + 0 \times 2 + 2 \times 3 + 6 \times 4 + 4 \times 5 + 0 \times 6 )}{( 0 + 0 + 2 + 6 + 4 + 0 )} = 4.2$$

When the position P calculated according to the above embodiment is 4.2, this indicates that the position of the spot S1 P is located between the 4^{th} (i=4) primary light sensing pixel 142D and the 5^{th} (i=5) primary light sensing pixel 142E. More specifically, the position of the spot S1 P is located at the midline between the 4^{th} (i=4) primary light sensing pixel 142D and the 5^{th} (i=5) primary light sensing pixel 142E but is closer to the primary light sensing pixel 142D. For example, the position of the spot S1 P is closer to the center line L1 of the 4^{th} (i=4) primary light sensing pixel 142D. In another example, when the value of the position P is substantially equivalent to 4.5, this indicates that the position of the spot S1 P is substantially located at the midline between the center line of the 4^{th} (i=4) primary light sensing pixel 142D and the center line of the 5^{th} (i=5) primary light sensing pixel 142E. In other example, when the value of the position P is smaller than 4, this indicates that the position of the spot S1 P is located between the 3^{rd} (i=3) primary light sensing pixel 142C and the 4^{th} (i=4) primary light sensing pixel 142D.

To summarize, the calculation of the position of the spot S1 P is based on the second sensing value SE2 detected by all secondary light sensing pixels enabled by the entire primary light sensing pixel (that is, the integral or the total sum of the sensing value detected by each secondary light sensing pixel of a primary light sensing pixel) rather than individual sensing values of a number of secondary light sensing pixels of a primary light sensing pixel, therefore the calculating speed of the position P of the spot S1 can be increased.

In step S170, a distance D1 between the position of the spot S1 and the test object 10 is obtained by the processor 150 according to the obtained position of the spot S1, wherein the processor 150 can adopt a generally known calculation method (such as the calculation method of similar triangles) of a total reflective type distance measuring device or a generally known calculation method of a diffuse type distance measuring device.

In an embodiment, the test object 10 and the device 100 can have relative movement. For example, at least one of the test object 10 and the device 100 moves, therefore the spot S1 and the light sensor 140 can move relatively. That is, the position of the spot S1 P is movable on the light sensor 140. Through the above detection process, the dynamic position P of the spot S1 and/or the corresponding distance D1 between the test object 10 and the device 100 can be detected immediately or proactively under dynamic change of the test object 10 and the device 100. Let a movable device 100 be taken for example. The movable device 100 can be used in a service robot, such as a cleaning robot or a vacuum cleaner, but the present disclosure is not limited thereto.

Although the device 100 of the above embodiment is exemplified by a distance measuring device, but the present disclosure is not limited thereto. In another embodiment, the device 100 can be a spot detecting device. In the present example, the process of FIG. 2 can omit step S170.

Although the extending direction of the primary light sensing pixel of the device 100 is exemplified by a vertical direction in above embodiments, the extending direction can also be exemplified by a horizontal direction. For example, after the light sensor 140 of the device 100 of FIG. 3 is rotated anti-clockwise or clockwise by 90°, the extending direction of the primary sensing pixel of the light sensor 140 will change to a horizontal direction. In the present example, the detection process of the spot S1 is similar or identical to that of the above embodiments, and the similarities are not repeated here.

Referring to FIG. 4, a measurement error curve C1 of the position P of the spot S1 measured by the device 100 of FIG. 1. The horizontal axis represents the measured distance D1, and the vertical axis represents the standard error of measurement. The standard error of measurement represents measurement error, and the smaller the measurement error, the higher the precision of the measured position P of the spot S1, and the smaller the error of the measured distance D1. Conversely, the larger the measurement error, the lower the precision of the measured position P of the spot S1, and the larger the error of the measured distance D1. Curve C1 of FIG. 4 represents the error values obtained when the device 100 of the present disclosure merely enables the primary light sensing pixels 142C to 142E (corresponding to step S160), and other curves C2 to C4 respectively represent the error values obtained when more primary light sensing pixels are enabled by the device 100. For example, curve C2 represents the error values obtained when the primary light sensing pixels 142B to 142E are enabled; curve C3 represents the error values obtained when the primary light sensing pixels 142A to 142E are enabled; curve C4 represents the error values obtained when the primary light sensing pixels 142A to 142F are enabled. A comparison of these curves shows that suppose the measured distance D1 is the same, the smallest error value is obtained when only primary light sensing pixels 142C to 142E of the region of the spot S1 are enabled. The comparison suffices to prove that the device 100 of the present disclosure can improve the precision of the position of the spot S1 P and the precision of the measured distance D1.

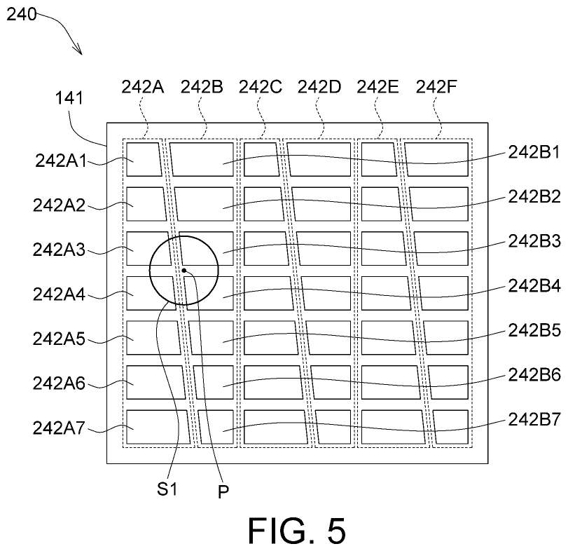

Referring to FIG. 5, a schematic diagram of primary light sensing pixels 242A to 242F of the light sensor 240 of the device according to another embodiment of the present disclosure is shown. The device of the present embodiment can be realized by a distance measuring device or a spot position detecting device. The device may include a light source 110 (not illustrated), a first lens 120 (not illustrated), a second lens 130 (not illustrated), a light sensor 240 and a processor 150 (not illustrated).

The light sensor 240 includes a substrate 141 and a number of primary light sensing pixels, such as primary light sensing pixels 242A to 242F, wherein the primary light sensing pixels 242A to 242F are formed on the substrate 141 to sense the intensity of the spot S1. Each of the primary light sensing pixels 242A to 242F generates a signal, such as a current or a voltage, according to the received intensity. The processor 150 is electrically connected to the light sensor 240 to receive a signal from the light sensor 140 and further calculates the position of the spot S1 according to the received signal.

As indicated in FIG. 5, each primary light sensing pixel includes a number of light sensing pixels. Let the primary light sensing pixel 242A of the primary light sensing pixels be taken for example. The primary light sensing pixel 242A includes a number of secondary light sensing pixels 242A1 to 242A7. However, neither the quantity of the primary light sensing pixels of the light sensor 240 nor the quantity of the secondary light sensing pixels of each light sensing pixel is subjected to any restrictions in the present disclosure. Besides, the present embodiment is different from the above embodiments in that, in the present embodiment, the area of each secondary light sensing pixel of each primary light sensing pixel 242A to 242F is different. For example, the area of a number of secondary light sensing pixels of each of the primary light sensing pixels 242A to 242F changes progressively. In an embodiment, each secondary light sensing pixel of each primary light sensing pixel can be a polygon, a circle or an oval, wherein the polygon can be a trapezoid or other shape of polygon, such as a triangle. In an embodiment, the shape of each secondary light sensing pixel of each primary light sensing pixel can be formed of straight lines, curves or a combination thereof, and is not limited to above exemplifications.

Let two adjacent primary light sensing pixels 242A and 242B of FIG. 5 be taken for example. The area of the secondary light sensing pixels 242A1 to 242A7 of the primary light sensing pixel 242A increases progressively along a first direction, and the area of the secondary light sensing pixels 242B1 to 242B7 of the primary light sensing pixel 242B increases progressively along a second direction, wherein the first direction is inverse to the second direction. As indicated in FIG. 5, the first direction is a downward direction, and the second direction is an upward direction. The change in the area of the secondary light sensing pixel of other two adjacent primary light sensing pixels is similar to that of the secondary light sensing pixel of two adjacent primary light sensing pixels disclosed above, and the similarities are not repeated here.

Since the area of the secondary light sensing pixels changes inversely between two adjacent primary light sensing pixels, when the spot S1 falls on two adjacent primary light sensing pixels, whether the spot S1 is substantially located at the region of the two adjacent primary light sensing pixels can be determined according to the ratio of the sensing values detected by the two adjacent primary light sensing pixels. For example, whether the spot S1 is substantially located at the middle region, the upper middle region or the lower middle region of the two adjacent primary light sensing pixels can be determined.

Let the two adjacent primary light sensing pixels 242A and 242B be taken for example. Refer to the step of S130 of FIG. 2. The region in which the spot S1 is located is determined by the processor 150 according to a ratio RA1 (SE1/SE2) of the first sensing value SE1 detected by the primary light sensing pixel 242A to the first sensing value SE1 detected by the primary light sensing pixel 242B. For example, when the ratio RA1 is substantially is equivalent to 1, this indicates that the first sensing value SE1 detected by the primary light sensing pixel 242A and that detected by the primary light sensing pixel 242B are substantially identical, and the corresponding position of the spot S1 is substantially located at the middle region of the two primary light sensing pixels 242A and 242B. When the ratio RA1 is smaller than 1, this indicates that the first sensing value SE1 detected by the primary light sensing pixel 242A is smaller than the first sensing value SE1 detected by the primary light sensing pixel 242B, and the corresponding the position of the spot S1 is substantially located at the upper middle region of the two primary light sensing pixels 242A and 242B (this is because the upper middle region of the primary light sensing pixel 242A has a smaller area and therefore absorbs less intensity than the primary light sensing pixel 242B). When the ratio RA1 is larger than 1, this indicates that the first sensing value SE1 detected by the primary light sensing pixel 242A is larger than the first sensing value SE1 detected by the primary light sensing pixel 242B, and the corresponding the position of the spot S1 is substantially located at the lower middle region of the two primary light sensing pixels 242A and 242B (this is because the lower middle region of the primary light sensing pixel 242A has a larger area and therefore absorbs more intensity than the primary light sensing pixel 242B).

Additionally, the device 100 may further include a reference table (not illustrated) recording correspondence relationship between the ratio RA1 and the region of the spot. In step S130, the region of the spot S1 can be obtained by the processor 150 by looking up the reference table according to the ratio RA1 or calculated by the processor 150 according to the reference table. The reference table can be obtained beforehand through tests or experiments, and can be stored in the processor 150 or another memory.

Moreover, when the ratio between the two first sensing values of the two adjacent primary light sensing pixels is not within a predetermined range, this indicates that the spot S1 is not located on the two adjacent primary light sensing pixels, and the processor 150 compares two first sensing values of a next group of two adjacent primary light sensing pixels. For example, when the ratio RA1 of the first sensing value SE1 of the primary light sensing pixel 242A to the first sensing value SE1 of the primary light sensing pixel 242B is not within a predetermined range, this indicates that the spot S1 is not simultaneously located on the two adjacent primary light sensing pixels 242A and 242B (the spot S1 may be located on other two adjacent primary light sensing pixels), the processor 150 calculates the ratio between two first sensing values of a next group of two adjacent primary light sensing pixels. For example, the processor 150 calculates the ratio RA1 between the two first sensing values of a next group of primary light sensing pixels 242B and 242C. The said predetermined range is such as in a range of 0.01 to 100. After comparing every two adjacent primary light sensing pixels, the processor 150 can then obtain the region of the spot S1. Let the quantity of the primary light sensing pixels be N. The processor 150 needs to calculate the ratio RA1 for (N−1) groups of two adjacent primary light sensing pixels. When N is equivalent to 6, the processor 150 needs to calculate the ratio RA1 for five groups of two adjacent primary light sensing pixels, and obtains five ratios RA1 in total.

Other steps of detecting the position of the spot S1 by the device of the present disclosure (such as steps S110 to S120 and steps S140 to S170) are similar to the corresponding steps of the device 100, and the similarities are not repeated here.

Although the extending direction of the primary light sensing pixels 242A to 242 of FIG. 5 is exemplified by a vertical direction in above embodiments, the extending direction can also be exemplified by a horizontal direction. For example, after the light sensor 240 of FIG. 5 is rotated anti-clockwise or clockwise by 90°, the extending direction of the primary sensing pixel of the light sensor 240 will change to a horizontal direction. In the present example, the detection process of the spot S1 is similar or identical to that of the above embodiments, and the similarities are not repeated here.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for detecting a spot position, comprising:
enabling a plurality of primary light sensing pixels each comprising a plurality of secondary light sensing pixels;
determining a region of the primary light sensing pixels in which a spot is located according to a first sensing value received by each primary light sensing pixel;
disabling the secondary light sensing pixels outside the region; and
obtaining a position of the spot according to a second sensing value received by the secondary light sensing pixels that are not disabled.

2. A method used in a distance measuring method of a distance measuring device, wherein the distance measuring device comprises a light source and a light sensor, the light sensor comprises a plurality of primary light sensing pixels each comprising a plurality of secondary light sensing pixels, and the method comprises:
emitting a first measuring light to a test object by the light source;
enabling the primary light sensing pixels;
determining a region of the primary light sensing pixels in which a spot of a first reflective light is located according to a first sensing value of the first reflective light received by each primary light sensing pixel;
disabling the secondary light sensing pixels outside the region;
emitting a second measuring light to the test object by the light source;
obtaining a position of a spot of a second reflective light according to a second sensing value of the second reflective light received by the secondary light sensing pixels that are not disabled; and
obtaining a distance between the device and the test object according to the position.

3. The method according to claim 1, wherein each secondary light sensing pixel of each primary light sensing pixel has the same area.

4. The method according to claim 2, wherein each secondary light sensing pixel of each primary light sensing pixel has the same area.

5. The method according to claim 1, wherein an area of the secondary light sensing pixels of each primary light sensing pixel changes progressively.

6. The method according to claim 2, wherein area of the secondary light sensing pixels of each primary light sensing pixel changes progressively.

7. The method according to claim 5, wherein the primary light sensing pixels comprise a first primary light sensing pixel and a second primary light sensing pixel adjacent to the first primary light sensing pixel, area of the secondary light sensing pixels of the first primary light sensing pixel increases progressively along a first direction, the area of the secondary light sensing pixels of the second primary light sensing pixel increases progressively along a second direction, and the first direction is inverse to the second direction.

8. The method according to claim 6, wherein the primary light sensing pixels comprise a first primary light sensing pixel and a second primary light sensing pixel adjacent to the first primary light sensing pixel, the area of the secondary light sensing pixels of the first primary light sensing pixel increases progressively along a first direction, the area of the secondary light sensing pixels of the second primary light sensing pixel increases progressively along a second direction, and the first direction is inverse to the second direction.

9. The method according to claim 5, wherein each primary light sensing pixel is a trapezoid or a triangle.

10. The method according to claim 6, wherein each primary light sensing pixel is a trapezoid or a triangle.

11. The method according to claim 8, wherein the step of determining the region of the primary light sensing pixels in which the spot is located according to the first sensing value received by each primary light sensing pixel comprises:
determining the region according to a ratio of the first sensing value of the first primary light sensing pixel to the first sensing value of the second primary light sensing pixel.

12. The method according to claim 1, wherein in the step of obtaining the position of the spot, the position is obtained according to a total sum of the sum of product of the second sensing value detected by the i^{th} primary light sensing pixel and i and the sum of the second sensing values detected by the primary light sensing pixels, wherein i is between 1 and N, and N is quantity of the primary light sensing pixels.

13. A device for detecting a spot position, comprising:
a light sensor, comprising a plurality of primary light sensing pixels each comprising a plurality of secondary light sensing pixels; and
a processor configured to:
enable the primary light sensing pixels;
determine a region of the primary light sensing pixels in which a spot is located according to a first sensing value received by each primary light sensing pixel;
disable the secondary light sensing pixels outside the region; and
obtain a position of the spot according to a second sensing value received by the secondary light sensing pixels that are not disabled.

14. A distance measuring device, comprising:
a light sensor, comprising a plurality of primary light sensing pixels each comprising a plurality of secondary light sensing pixels;
a light source configured to emit a first measuring light to a test object; and
a processor configured to:
enable the primary light sensing pixels;
determine a region of the primary light sensing pixels in which a spot of a first reflective light is located according to a first sensing value of the first reflective light received by each primary light sensing pixel; and
disable the secondary light sensing pixels outside the region;
wherein the light source is further configured to emit a second measuring light to the test object; and the processor is further configured to:
obtain a position of a spot of a second reflective light according to a second sensing value of the second reflective light received by the secondary light sensing pixels that are not disabled;
obtain a distance between the device and the test object according to the position.

15. The device according to claim 13, wherein each secondary light sensing pixel of each primary light sensing pixel has the same area.

16. The device according to claim 14, wherein each secondary light sensing pixel of each primary light sensing pixel has the same area.

17. The device according to claim 13, wherein an area of the secondary light sensing pixels of each primary light sensing pixel changes progressively.

18. The device according to claim 14, wherein an area of the secondary light sensing pixels of each primary light sensing pixel changes progressively.

19. The device according to claim 17, wherein the primary light sensing pixels comprise a first primary light sensing pixel and a second primary light sensing pixel adjacent to the first primary light sensing pixel, the area of the secondary light sensing pixels of the first primary light sensing pixel increases progressively along a first direction, the area of the secondary light sensing pixels of the second primary light sensing pixel increases progressively along a second direction, and the first direction is inverse to the second direction.

20. The device according to claim 18, wherein the primary light sensing pixels comprise a first primary light sensing pixel and a second primary light sensing pixel adjacent to the first primary light sensing pixel, the area of the secondary light sensing pixels of the first primary light sensing pixel increases progressively along a first direction, the area of the secondary light sensing pixels of the second primary light sensing pixel increases progressively along a second direction, and the first direction is inverse to the second direction.

21. The device according to claim 17, wherein each secondary light sensing pixel of each primary light sensing pixel is a trapezoid or a triangle.

22. The device according to claim 18, wherein each secondary light sensing pixel of each primary light sensing pixel is a trapezoid or a triangle.

23. The device according to claim 17, wherein the step of determining the region of the primary light sensing pixels in which the spot is located according to the first sensing value received by each primary light sensing pixel comprises:
determining the region according to a ratio of the first sensing value of a first primary light sensing pixel of the primary light sensing pixels to the first sensing value of a second primary light sensing pixel of the primary light sensing pixels.

24. The device according to claim 18, wherein the step of determining the region of the primary light sensing pixels in which the spot is located according to the first sensing value received by each primary light sensing pixel comprises:
determining the region according to a ratio of the first sensing value of a first primary light sensing pixel of the primary light sensing pixels to the first sensing value of a second primary light sensing pixel of the primary light sensing pixels.

25. The device according to claim 13, wherein in the step of obtaining the position of the spot, the position is determined according to a total sum of the sum of the product of the second sensing value detected by the i^{th} primary light sensing pixel and i and the sum of the second sensing values detected by the primary light sensing pixels, wherein i is between 1 and N, and N is quantity of the primary light sensing pixels.

26. The device according to claim 14, wherein in the step of obtaining the position of the spot, the position is determined according to a total sum of the sum of the product of the second sensing value detected by the i^{th} primary light sensing pixel and i and the sum of the second sensing values detected by the primary light sensing pixels, wherein i is between 1 and N, and N is quantity of the primary light sensing pixels.
